(19) United States
(12) Patent Application Publication
(10) Pub. No.: US 2026/0295485 A1
(43) Pub. Date: Oct. 1, 2026

(54) LIQUID SEPARATOR DEVICE AND METHOD OF USE

(71) Applicant: Pall Corporation, Port Washington, NY (US)

(72) Inventors: James Duncan Fitzhardinge ROBB, Port Washington, NY (US); Simon James WITHERS, Port Washington, NY (US)

(21) Appl. No.: 19/478,737

(22) PCT Filed: Jun. 4, 2024
(86) PCT No.: PCT/US2024/032410

§ 371 Date: Oct. 24, 2025

Related U.S. Application Data
(60) Provisional application No. 63/523,787, filed on Jun. 28, 2023.

(51) Int. Cl. B01D 45/16; H01M 8/04119

(52) U.S. Cl. CPC B01D 45/16; H01M 8/04164

(57) ABSTRACT

A liquid separator device, a method of using the liquid separator device, and a system including at least one liquid separator device, are disclosed.

### BACKGROUND OF THE INVENTION

For applications involving fuel cells, liquid (e.g., water) is separated from gas (e.g., hydrogen). However, there may still be some gas associated with the separated water after passing through the fuel cell and/or it may be desirable to separate some water from gas before gas associated with the remaining water is passed through the fuel cell. For some applications, it may be desirable to process fluid containing water and gas to separate water from gas before and/or after passing water and gas through the fuel cell.

The invention provides a liquid separator device suitable for use upstream and/or downstream of a fuel cell.

The present invention provides for ameliorating at least some of the disadvantages of the prior art. These and other advantages of the present invention will be apparent from the description as set forth below.

### BRIEF SUMMARY OF THE INVENTION

An aspect of the invention provides a liquid separator device comprising (a) a hollow inlet duct having a first open inlet duct end and a second open inlet duct end, the second open inlet duct end further comprising a first housing end cap; (b) a hollow separation duct having an inner separation duct wall, an outer separation duct wall, a plurality of venturi flow radial slits passing through the outer and inner separation duct walls; a first open separation duct end, a second open separation duct end; a separation cavity from the first open separation duct end to the second open separation duct end bounded by the inner separation duct wall, wherein the first housing end cap of the second open inlet duct end is arranged coaxially in the first open separation duct end, with a first annular space between the first housing end cap and the first open separation duct end: (c) a vortex generator comprising a plurality of helical vanes, arranged concentrically within the hollow inlet duct, and retained axially between the first open separation duct end and the second open inlet duct end including the first housing end cap; (d) a hollow outlet duct having a first open outlet duct end and a second open outlet duct end: (e) a hollow housing having an inner housing wall, an outer housing wall, a first open housing end, an oppositely arranged second open housing end, with a horizontal axis between the first open housing end and the oppositely arranged second open housing end, and a third open housing end arranged perpendicular to the horizontal axis or parallel to the horizontal axis, wherein the separation duct is arranged concentrically along the horizontal axis within the hollow housing; (f) the first housing end cap of the second open inlet duct end connected concentrically to the first open housing end: (g) a second housing end cap connected concentrically to both the second open housing end and the hollow outlet duct; (h) a hollow collection sump having a first open sump end and a second open sump end, wherein the first open sump end is connected to the third open housing end, the hollow collection sump including an orifice restricting flow therethrough; (i) a collection cavity within the hollow housing, surrounding the outer wall of the hollow separation duct, bounded by the first housing end cap of the second open inlet duct, the second housing end cap, and the first open sump end; wherein the second open separation duct end is arranged coaxially with respect to the first open outlet duct end, with a second annular space between the second open separation duct end and the first open outlet duct end, the second annular space providing a fluid flow path from the separation cavity to the collection cavity.

In another aspect of the invention, a liquid separator device is provided comprising (a) a hollow inlet duct having a first open inlet duct end and a second open inlet duct end, the second open inlet duct end further comprising a first housing end cap; (b) a hollow separation duct having an inner separation duct wall, and an outer separation duct wall further comprising a collar having an outwardly extending tapered collar wall and a collar lip, a plurality of venturi flow radial openings passing through the collar lip and the inner separation duct wall; a first open separation duct end and a second open separation duct end, wherein the collar is arranged between the first open separation duct end and the second open separation duct end; a separation cavity from the first open separation duct end to the second open separation duct end bounded by the inner separation duct wall, wherein the first housing end cap of the second open inlet duct end is arranged coaxially in the first open separation duct end, with a first annular space between the first housing end cap and the first open separation duct end; (c) a vortex generator comprising a plurality of helical vanes, arranged concentrically within the hollow inlet duct, and retained axially between the first open separation duct end and the second open inlet duct end including the first housing end cap; (d) a hollow outlet duct having a first open outlet duct end and a second open outlet duct end, the second open outlet duct end further comprising a second housing end cap; (e) a hollow housing having an inner housing wall, an outer housing wall, a first open housing end, an oppositely arranged second open housing end, with a horizontal axis between the first open housing end and the oppositely arranged second open housing end, wherein the separation duct is arranged concentrically along the horizontal axis within the hollow housing; (f) the first housing end cap of the second open inlet duct end connected concentrically to the first open housing end; (g) the second housing end cap of the first open outlet duct end connected concentrically to both the second open housing end and the hollow outlet duct; (h) a hollow collection sump port in fluid communication with the first housing end cap of the second open inlet duct end, or in fluid communication with the outer housing wall adjacent the second housing end cap of the first open outlet duct end, the hollow collection sump port including an orifice restricting flow therethrough; (i) a collection cavity within the hollow housing, surrounding the outer separation duct wall including the collar of the hollow separation duct, bounded by the first housing end cap of the second open inlet duct end, the second housing end cap of the first open outlet duct end, and the hollow collection sump port; wherein the second open separation duct end is arranged coaxially with respect to the first open outlet duct end, with a second annular space between the second open separation duct end and the first open outlet duct end, the second annular space providing a fluid flow path from the separation cavity to the collection cavity.

In accordance with another aspect of the invention, a liquid separator system comprises comprising a fuel cell having an anode side and a cathode side, and an aspect of the liquid separator device in fluid communication with the cathode side, wherein the liquid separator device is arranged upstream of the cathode side.

Alternatively, or additionally, in accordance with an aspect of the invention, a liquid separator system comprises a fuel cell having an anode side and a cathode side, and an aspect of the liquid separator device in fluid communication with the anode side, wherein the liquid separator device is arranged downstream of the anode side.

A method for processing fluid according to an aspect of the invention comprises passing a fluid comprising liquid (e.g., water or oil) and gas (e.g., air or hydrogen) into an aspect of the liquid separator device, and separating liquid from gas, including passing separated gas through the hollow outlet duct, and passing separated liquid through the hollow collection sump or the hollow collection sump port.

### BRIEF DESCRIPTION OF THE SEVERAL VIEWS OF THE DRAWING(S)

FIGS. 1A-1F are drawings showing a water separation device according to an aspect of the invention, wherein FIG. 1A shows an isometric view; FIG. 1B shows a cross-sectional view; FIG. 1C shows a front view; FIG. 1D shows a right side view;

FIG. 1E shows an inner view along line G-G of FIG. 1D, also showing the first open end of the separation duct concentric to the second open end of the inlet duct with radial slits; and FIG. 1F shows an inner view along line E-E of FIG. 1D, also showing the second second end of the separation duct concentric to the first open end of the outlet duct.

FIGS. 2A-2B are drawings showing exploded views of the water separation device shown in FIG. 1A, viewed from the rear and front, respectively, wherein the water separation device includes a combined inlet duct/first housing end cap, a vortex generator, a separation duct with radial slits, a housing, an outlet duct, a collection sump, and an orifice (illustrated as an orifice fitting), and a second housing end cap. FIGS. 2C and 2D are drawings showing, respectively, a front view and an isometric view of the separation duct shown in FIGS. 2A-2B.

FIGS. 3A-3D are drawings showing, respectively, front, left, top, and isometric views of the orifice fitting shown in FIGS. 2A-2B FIG. 4 is a drawing illustrating venturi-induced air cycling during fluid flow through the aspect of the water separation device shown in FIG. 1A.

FIGS. 5A-5F are drawings showing a water separation device according to another aspect of the invention, wherein FIG. 5A shows an isometric view; FIG. 5B shows a cross-sectional view; FIG. 5C shows a rear view; FIG. 5D shows a left side view; FIG. 5E shows an inner view along line C-C of FIG. 5D, also showing angularly aligned radial openings; and FIG. 5F shows an inner view along line B-B of FIG. 5D, also showing the first open end of the separation duct concentric to the second open end of the inlet duct.

FIGS. 6A-6B are drawings showing exploded views of the water separation device shown in FIG. 5A, viewed from the rear and front, respectively, wherein the water separation device includes a combined inlet duct/first housing end cap, a vortex generator, a separation duct with radial holes, a housing, a combined outlet duct/second housing end cap, a collection sump, also showing an orifice fitting at different locations depending on the operation of the device. FIG. 6C is a drawing showing a front view of the separation duct shown in FIGS. 6A-6B. FIGS. 6D and 6E are drawings showing the separation duct shown in FIGS. 6A-6B viewed from the rear and front, respectively.

FIG. 7A is a drawing illustrating venturi-induced air cycling during fluid flow through the aspect of the water separation device shown in FIG. 5A when operated in a vertical configuration, and FIG. 7B is a drawing illustrating venturi-induced air cycling during fluid flow through the aspect of the water separation device shown in FIG. 5A when operated in a horizontal configuration,.

FIG. 8 is a drawing showing, diagrammatically, that water separation devices according to aspects of the invention can be arranged upstream and/or downstream of fuel cells according to aspects of the invention.

### DETAILED DESCRIPTION OF THE INVENTION

An aspect of the invention provides a liquid separator device comprising (a) a hollow inlet duct having a first open inlet duct end and a second open inlet duct end, the second open inlet duct end further comprising a first housing end cap; (b) a hollow separation duct having an inner separation duct wall, an outer separation duct wall, a plurality of venturi flow radial slits passing through the outer and inner separation duct walls; a first open separation duct end, a second open separation duct end; a separation cavity from the first open separation duct end to the second open separation duct end bounded by the inner separation duct wall, wherein the first housing end cap of the second open inlet duct end is arranged coaxially in the first open separation duct end, with a first annular space between the first housing end cap and the first open separation duct end; (c) a vortex generator comprising a plurality of helical vanes, arranged concentrically within the hollow inlet duct, and retained axially between the first open separation duct end and the second open inlet duct end including the first housing end cap; (d) a hollow outlet duct having a first open outlet duct end and a second open outlet duct end: (e) a hollow housing having an inner housing wall, an outer housing wall, a first open housing end, an oppositely arranged second open housing end, with a horizontal axis between the first open housing end and the oppositely arranged second open housing end, and a third open housing end arranged perpendicular to the horizontal axis or parallel to the horizontal axis, wherein the separation duct is arranged concentrically along the horizontal axis within the hollow housing; (f) the first housing end cap of the second open inlet duct end connected concentrically to the first open housing end; (g) a second housing end cap connected concentrically to both the second open housing end and the hollow outlet duct; (h) a hollow collection sump having a first open sump end and a second open sump end, wherein the first open sump end is connected to the third open housing end, the hollow collection sump including an orifice restricting flow therethrough: (i) a collection cavity within the hollow housing, surrounding the outer wall of the hollow separation duct, bounded by the first housing end cap of the second open inlet duct end, the second housing end cap, and the first open sump end; wherein the second open separation duct end is arranged coaxially with respect to the first open outlet duct end, with a second annular space between the second open separation duct end and the first open outlet duct end, the second annular space providing a fluid flow path from the separation cavity to the collection cavity.

In another aspect of the invention, a liquid separator device is provided comprising (a) a hollow inlet duct having a first open inlet duct end and a second open inlet duct end, the second open inlet duct end further comprising a first housing end cap; (b) a hollow separation duct having an inner separation duct wall, and an outer separation duct wall further comprising a collar having an outwardly extending tapered collar wall and a collar lip, a plurality of venturi flow radial openings passing through the collar lip and the inner separation duct wall; a first open separation duct end and a second open separation duct end, wherein the collar is arranged between the first open separation duct end and the second open separation duct end; a separation cavity from the first open separation duct end to the second open separation duct end bounded by the inner separation duct wall, wherein the first housing end cap of the second open inlet duct end is arranged coaxially in the first open separation duct end, with a first annular space between the first housing end cap and the first open separation duct end; (c) a vortex generator comprising a plurality of helical vanes, arranged concentrically within the hollow inlet duct, and retained axially between the first open separation duct end and the second open inlet duct end including the first housing end cap: (d) a hollow outlet duct having a first open outlet duct end and a second open outlet duct end, the second open outlet duct end further comprising a second housing end cap; (e) a hollow housing having an inner housing wall, an outer housing wall, a first open housing end, an oppositely arranged second open housing end, with a horizontal axis between the first open housing end and the oppositely arranged second open housing end, wherein the separation duct is arranged concentrically along the horizontal axis within the hollow housing; (f) the first housing end cap of the second open inlet duct end connected concentrically to the first open housing end; (g) the second housing end cap of the first open outlet duct end connected concentrically to both the second open housing end and the hollow outlet duct: (h) a hollow collection sump port in fluid communication with the first housing end cap of the second open inlet duct end, or in fluid communication with the hollow housing adjacent the second housing end cap of the first open outlet duct end, the hollow collection sump port including an orifice restricting flow therethrough; (i) a collection cavity within the hollow housing, surrounding the outer separation duct wall including the collar of the hollow separation duct, bounded by the first housing end cap of the second open inlet duct end, the second housing end cap of the first open outlet duct end, and the hollow collection sump port; wherein the second open separation duct end is arranged coaxially with respect to the first open outlet duct end, with a second annular space between the second open separation duct end and the first open outlet duct end, the second annular space providing a fluid flow path from the separation cavity to the collection cavity.

In accordance with another aspect of the invention, a liquid separator system comprises comprising a fuel cell having an anode side and a cathode side, and an aspect of the liquid separator device in fluid communication with the cathode side, wherein the liquid separator device is arranged upstream of the cathode side.

Alternatively, or additionally, in accordance with an aspect of the invention, a liquid separator system comprises a fuel cell having an anode side and a cathode side, and a liquid separator device in fluid communication with the anode side, wherein the liquid separator device is arranged downstream of the anode side.

A method for processing fluid according to an aspect of the invention comprises passing a fluid comprising liquid (e.g., water or oil) and gas (e.g., air or hydrogen) into an aspect of the liquid separator device, and separating liquid from gas, including passing separated gas through the hollow outlet duct, and passing separated liquid through the hollow collection sump or hollow collection sump port. In one aspect of the method, the liquid comprises water, and the gas comprises hydrogen.

Illustratively, in some aspects, the inlet duct transmits a mixed liquid/gas medium (which can include a spray form) to the vortex generator, which imparts a swirling motion to the mixed liquid/gas medium. Impaction with the vortex generator coalesces the airborne liquid droplets and the inertial effect of the swirling motion then forces the coalesced liquid to the outside of the inlet duct and on into the separation duct. The coaxial and overlapped relationship between the inlet duct second end and the separation duct first end is such that it forms an annular space/channel between these ends. Radial slits or radial openings in the separation duct connect the collection cavity to the separation cavity such that flowing air at velocity over the coaxial overlapping feature creates a venturi effect, which draws air from the collection cavity. Accordingly, the annular gap formed between the second end of the separator duct and the first end of the outlet duct provides a flow path for the coalesced liquid (e.g., water) to drain into the collection cavity.

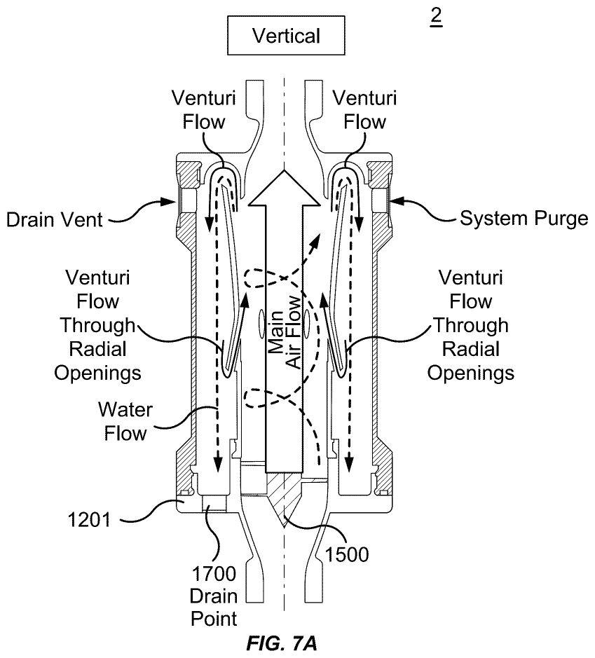

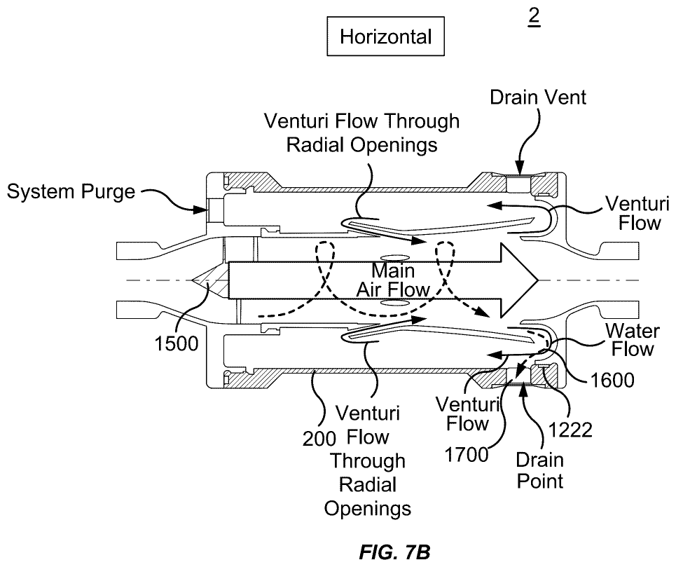

The movement of air from the collection cavity into the main mixed flow at the first end of the separation duct results in the opposite movement of air from the separation cavity into the collection cavity through the annular gap at the second end of the separation duct. This helps to draw the coalesced liquid through to the collection cavity and minimizes re-entrainment of the liquid. The two annular features laid out in this way create a cycling flow of air as depicted in FIGS. 4A, 7A, and 7B.

As the mixed gas and liquid flow reaches the outlet duct, the coalesced liquid (e.g., water), which by this point is flowing helically around the inner surface of the separation duct, drains into the collection cavity, and the cleaned process gas passes into the outlet duct and on into the downstream customer ducting. The hollow collection sump or hollow collection sump port fitted to the housing is where the liquid removed from the process gas flow collects.

An orifice (e.g., orifice plate or orifice fitting) incorporated into the scavenge interface at the hollow collection sump port or hollow collection sump second end restricts the flow of liquid and some gas sufficiently to enable removal of liquid into the scavenge pipework, and to limit the loss of process gas to below a specified level

In some aspects, removal efficiencies can be in the range of 80% to <99% removal of free liquid medium.

With respect to scavenging, the scavenge (or removal) flow rate is determined as a % of the total gaseous flow entering the device. In some aspects, the scavenge flow rate can be limited to 3% of total gaseous flow, or lower.

Aspects of the invention are particularly suitable for liquid-gas separation applications, with including aerospace fuel cell applications on both the anode gas (H₂) and cathode gas (O₂/Air) flow lines.

Advantageously, the venturi feature helps to create a cyclic flow movement of air from the collection cavity into the separation cavity at the first end of the separation duct, and from the separation cavity into the collection cavity at the second end of the separation duct. This minimizes the turbulent flow of air at the second end of the separation duct, prevents any bunching/pooling of liquid at that transition, minimizes re-entrainment of coalesced liquid back into the main airflow by drawing it through the annular opening into the collection cavity.

Each of the components of the invention will now be described in more detail below, wherein like components have like reference numbers.

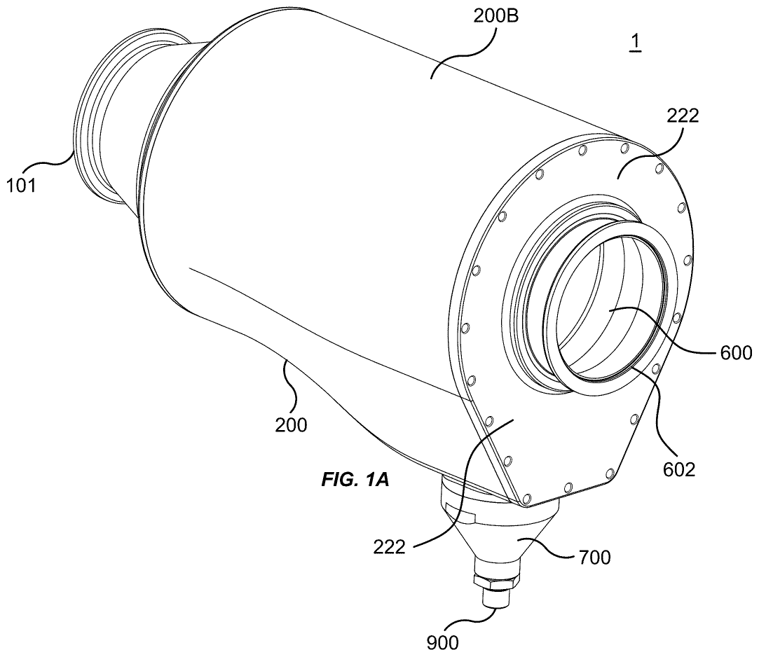

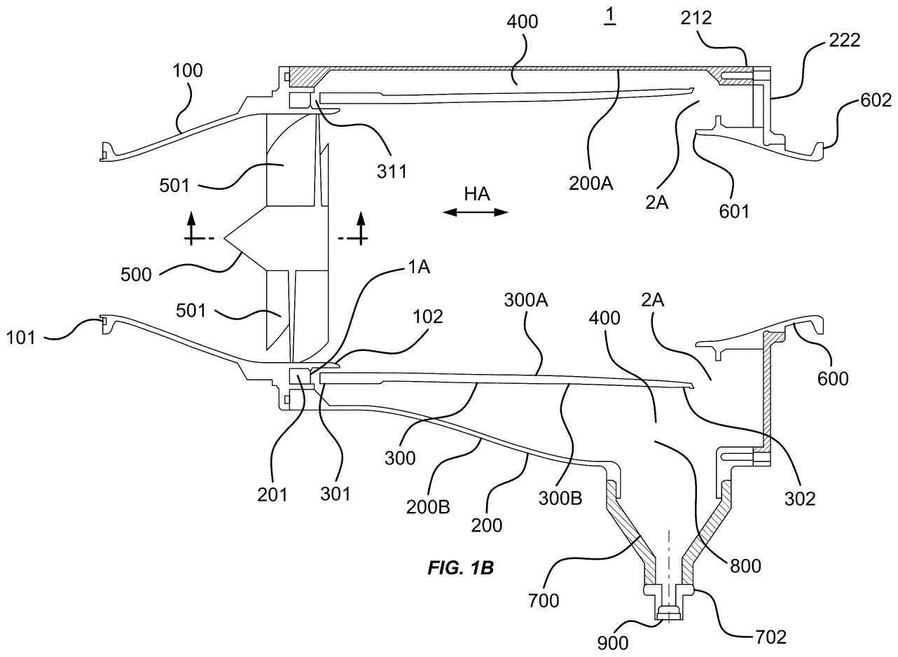

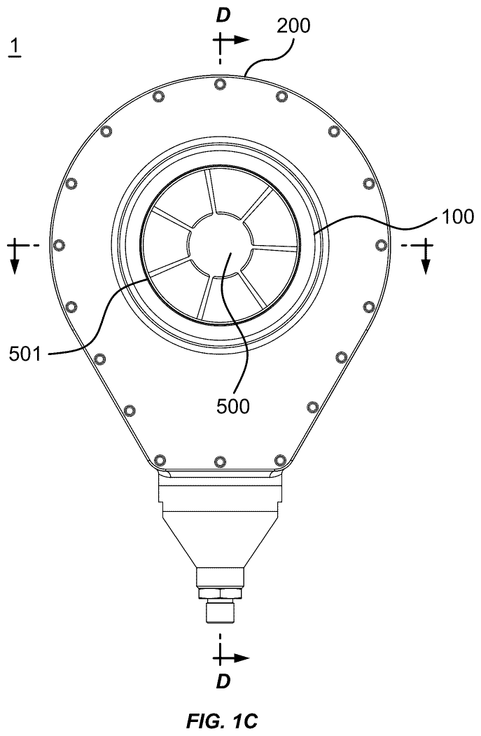

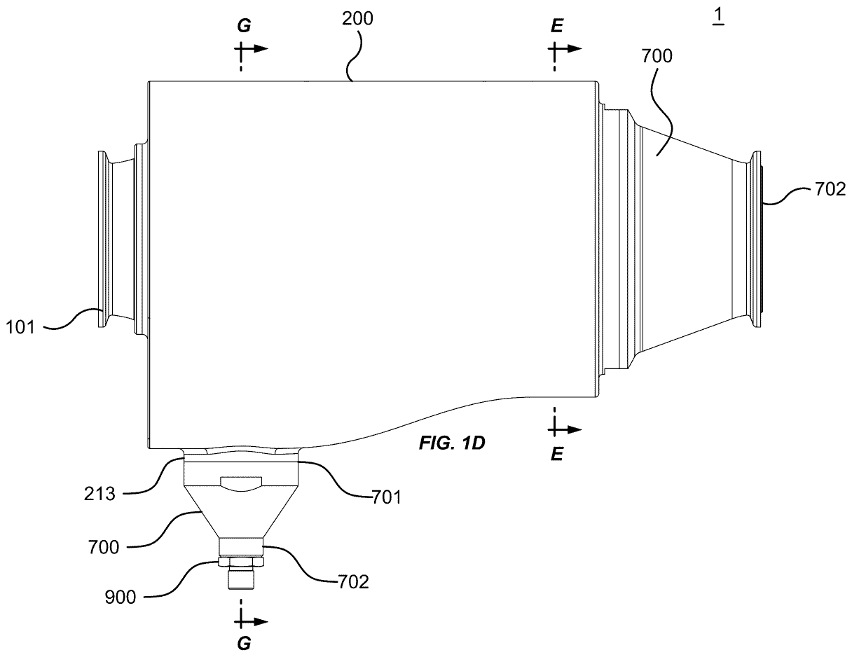

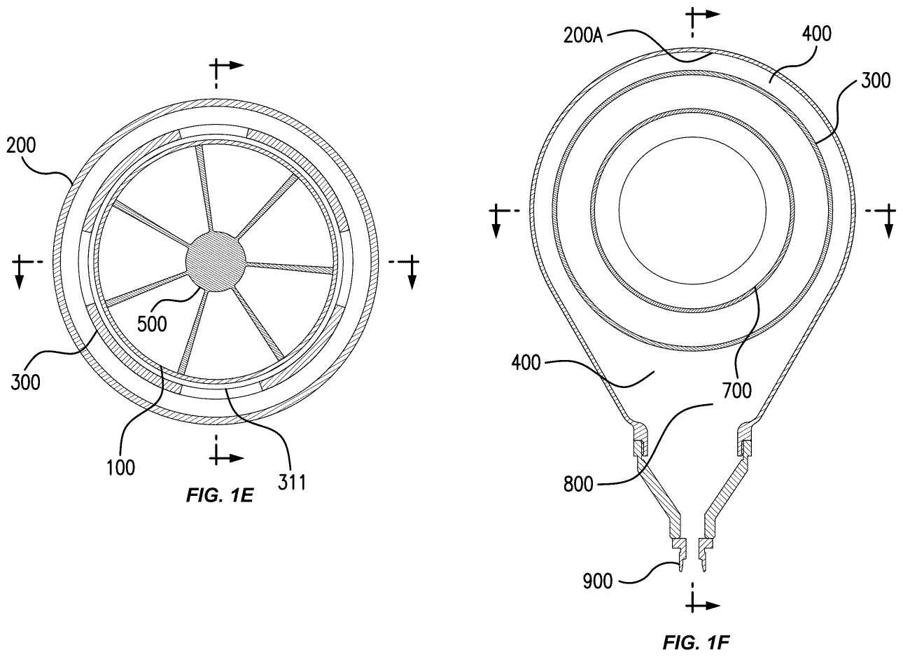

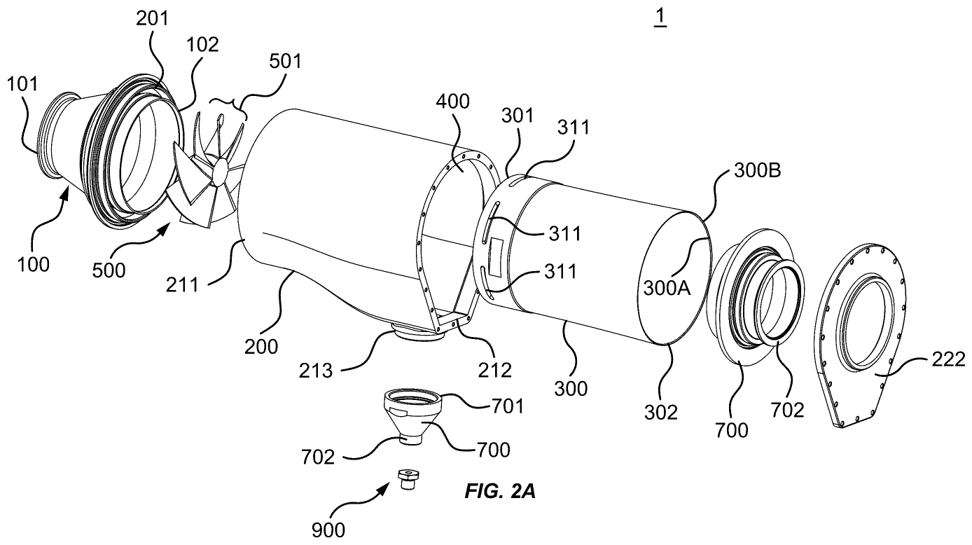

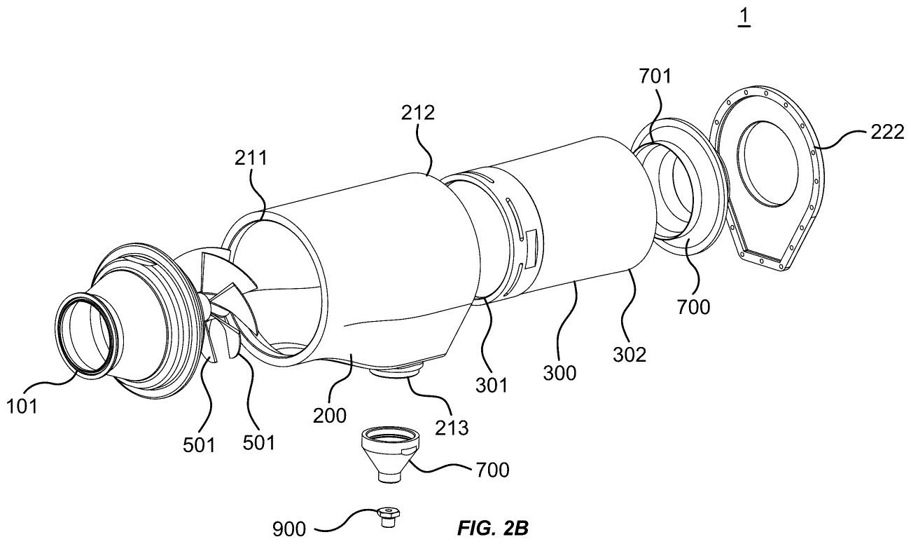

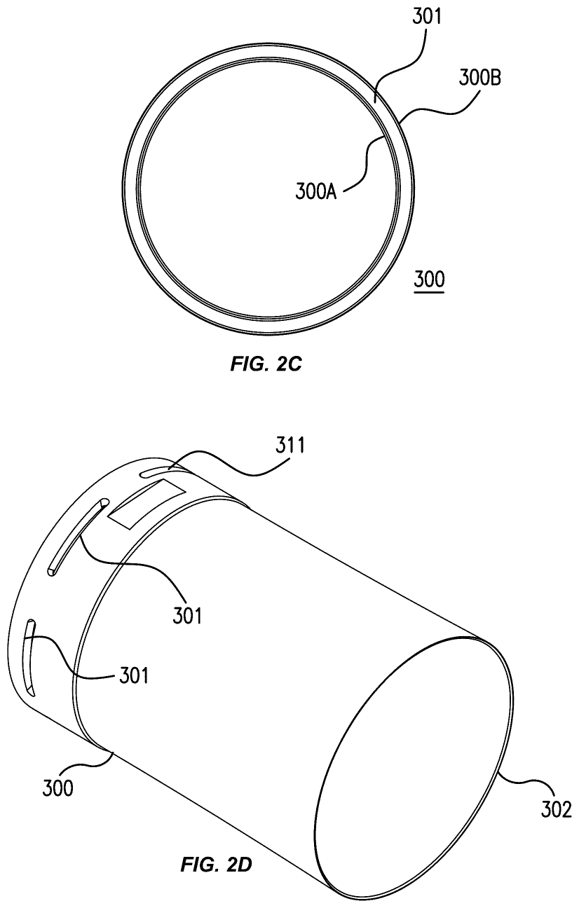

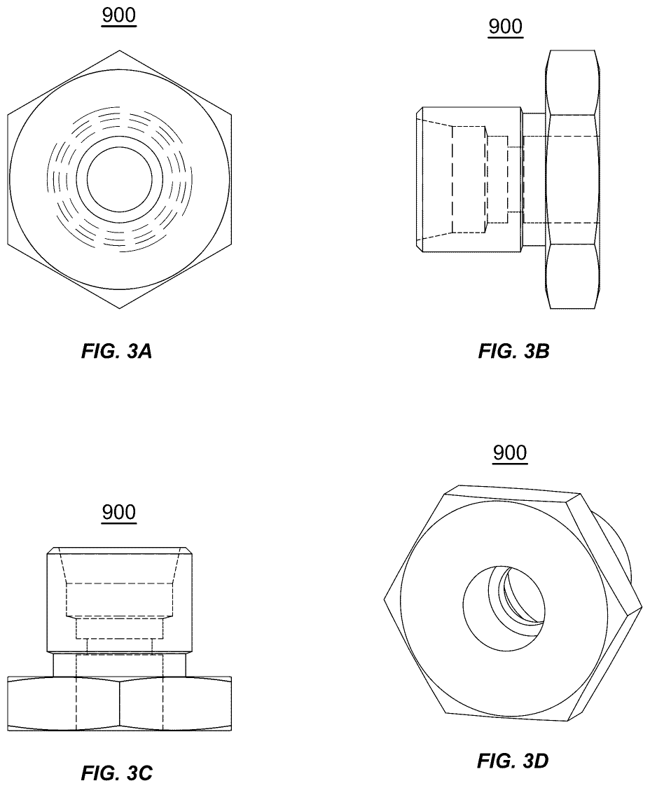

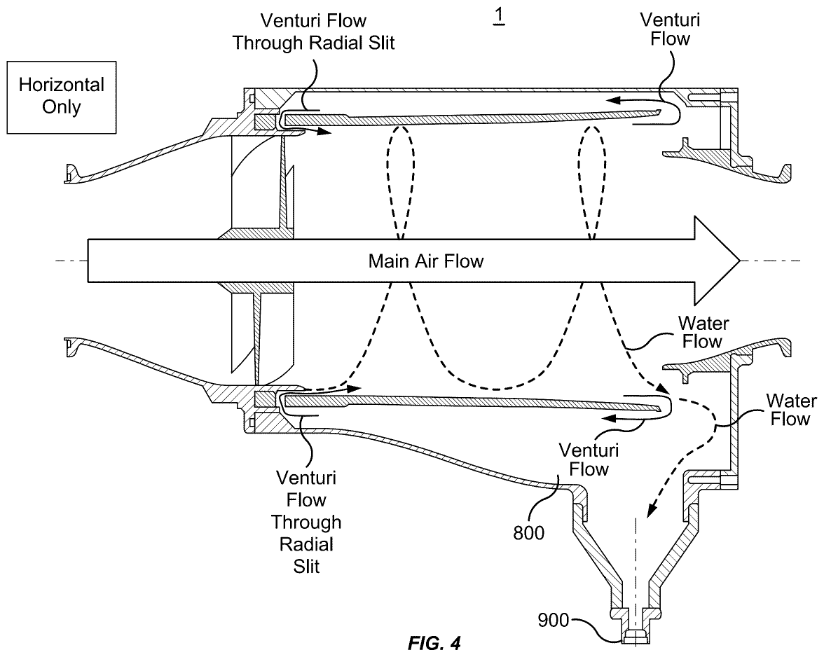

Using the illustrated aspect of the liquid separator device shown in FIGS. 1A-1F, and 2A-2B for reference, a liquid separator device 1 comprises (a) a hollow inlet duct 100 having a first open inlet duct end 101 and a second open inlet duct end 102, the second open inlet duct end further comprising a first housing end cap 201; (b) a hollow separation duct 300 having an inner separation duct wall 300A, an outer separation duct wall 300B, a plurality of venturi flow radial slits 311 passing through the outer and inner separation duct walls 300A, 300B; a first open separation duct end 301, a second open separation duct end 302; a separation cavity 400 from the first open separation duct end 301 to the second open separation duct end 302 bounded by the inner separation duct wall 300A, wherein the first housing end cap 201 of the second open inlet duct end 102 is arranged coaxially in the first open separation duct end 301, with a first annular space 1A between the first housing end cap 201 and the first open separation duct end 301; (c) a vortex generator 500 comprising a plurality of helical vanes 501, arranged concentrically within the hollow inlet duct 100, and retained axially (e.g., retained via an interference/press fit with a step to retain it axially) between the first open separation duct end 301 and the second open inlet duct end 102 including the first housing end cap 201; (d) a hollow outlet duct 600 having a first open outlet duct end 601 and a second open outlet duct end 602; (e) a hollow housing 200 having an inner housing wall 200A, an outer housing wall 200B, a first open housing end 211, an oppositely arranged second open housing end 212, with a horizontal axis HA between the first open housing end 211 and the oppositely arranged second open housing end 212, and a third open housing end 213 arranged perpendicular to the horizontal axis HA or parallel to the horizontal axis, wherein the separation duct 300 is arranged concentrically along the horizontal axis HA within the hollow housing 200; (f) the first housing end cap 201 of the second open inlet duct end 102 connected concentrically to the first open housing end 211; (g) a second housing end cap 222 connected concentrically to both the second open housing end 212 and the hollow outlet duct 600; (h) a hollow collection sump 700 having a first open sump end 701 and a second open sump end 702, wherein the first open sump end 701 is connected to the third open housing end 213, the hollow collection sump 700 including an orifice 900 (see also, FIGS. 3A-3D) restricting flow therethrough; (i) a collection cavity 800 within the hollow housing 200, surrounding the outer wall of the hollow separation duct 300B, bounded by the first housing end cap 201 of the second open inlet duct end 102, the second housing end cap 222, and the first open sump end 701; wherein the second open separation duct end 302 is arranged coaxially with respect to the first open outlet duct end 601, with a second annular space 2A between the second open separation duct end 302 and the first open outlet duct end 601, the second annular space 2A providing a fluid flow path from the separation cavity 400 to the collection cavity 800, and through the hollow collection sump. Optionally, the presence of an orifice (or orifice plate or orifice fitting) 900 at the second open sump end 702 (or as an alternative to an orifice, a separate drain valve) restricts the flow of liquid (water) and some gas sufficiently to enable removal of liquid into a scavenge pipework and limit the loss of process gas to below a specified level.

FIG. 4 is a drawing illustrating, schematically, venturi-induced air cycling during fluid flow through the illustrated aspect of the water separation device 1000, wherein a portion of the venturi-induced air flow passes through the radial slits.

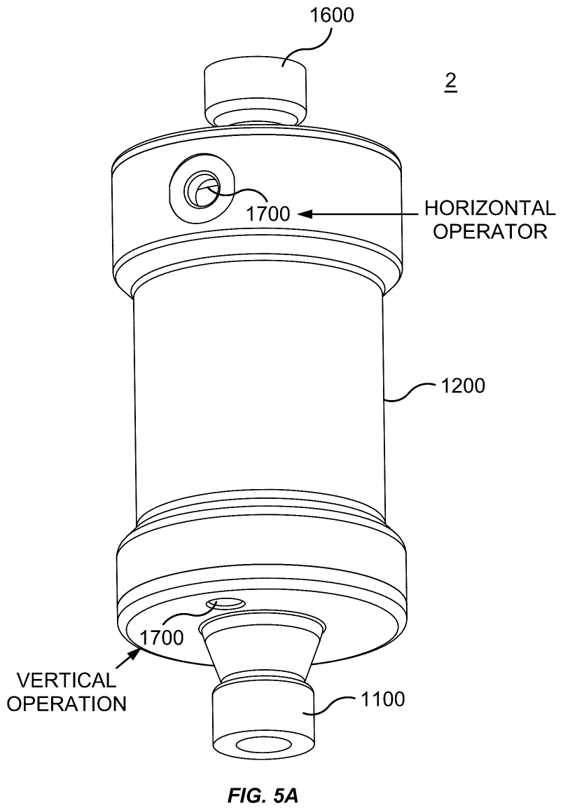

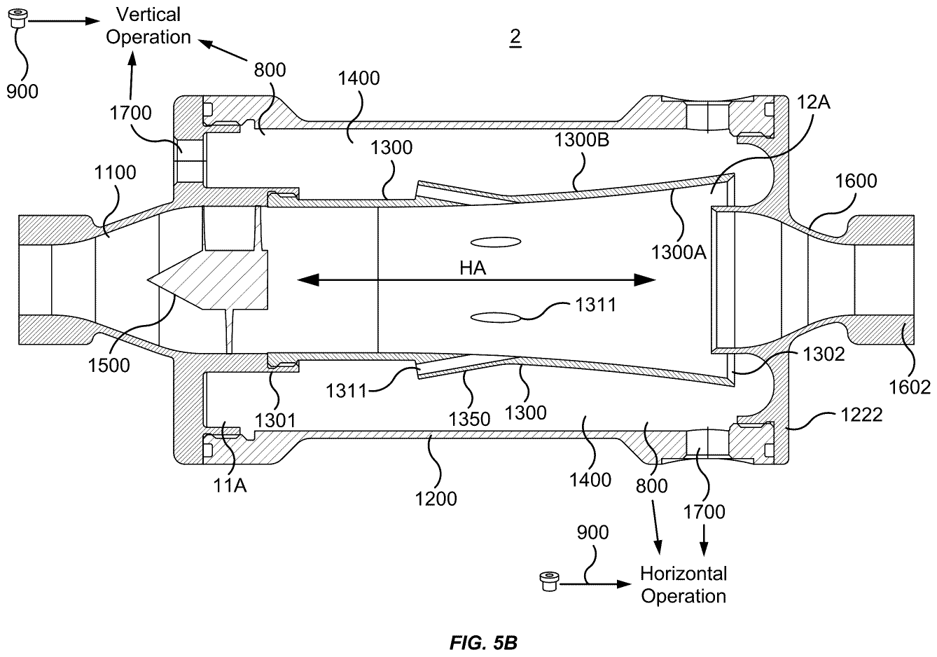

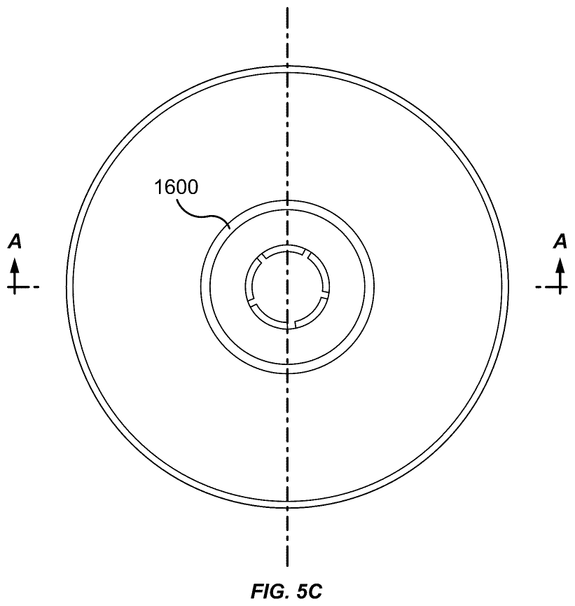

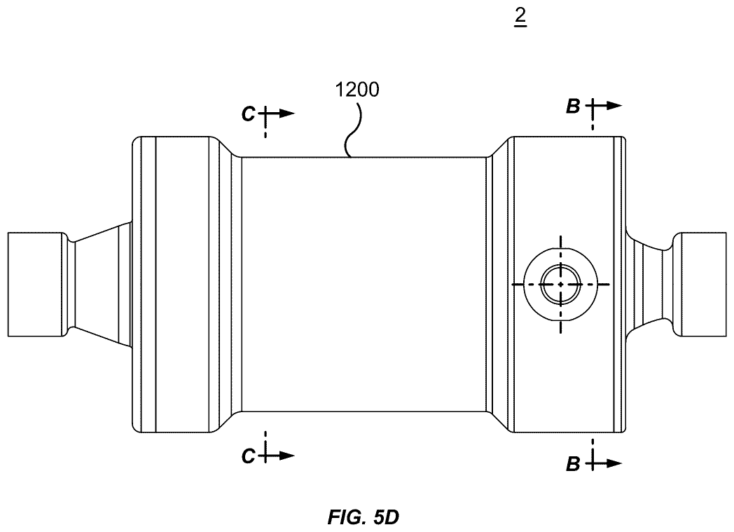

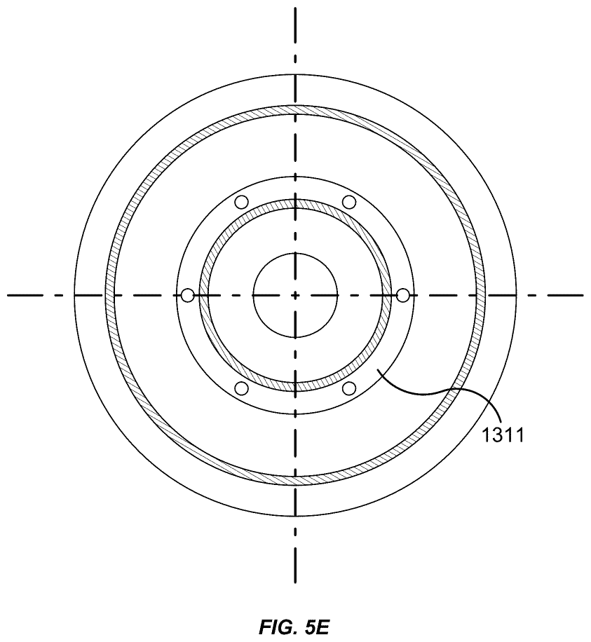

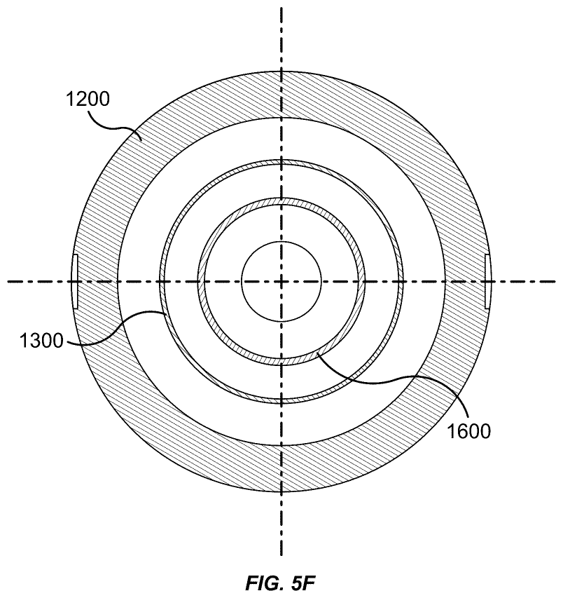

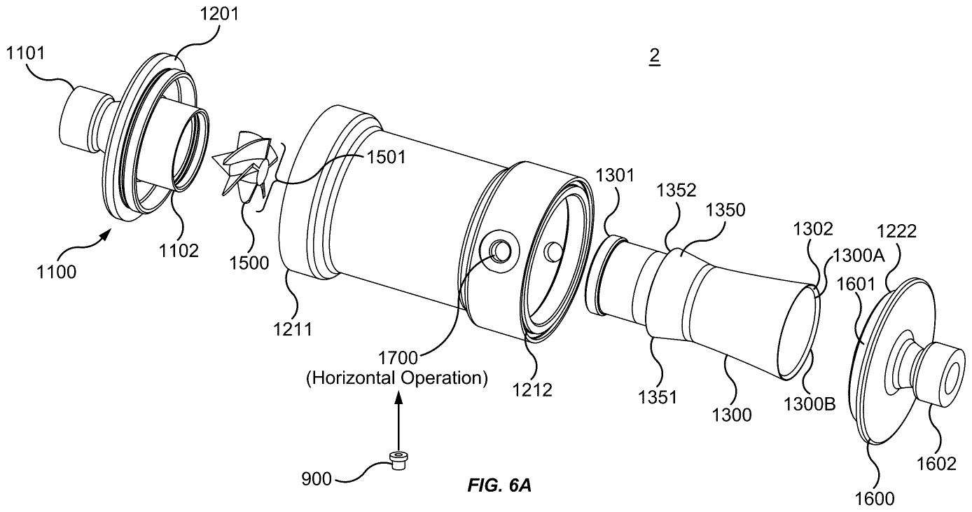

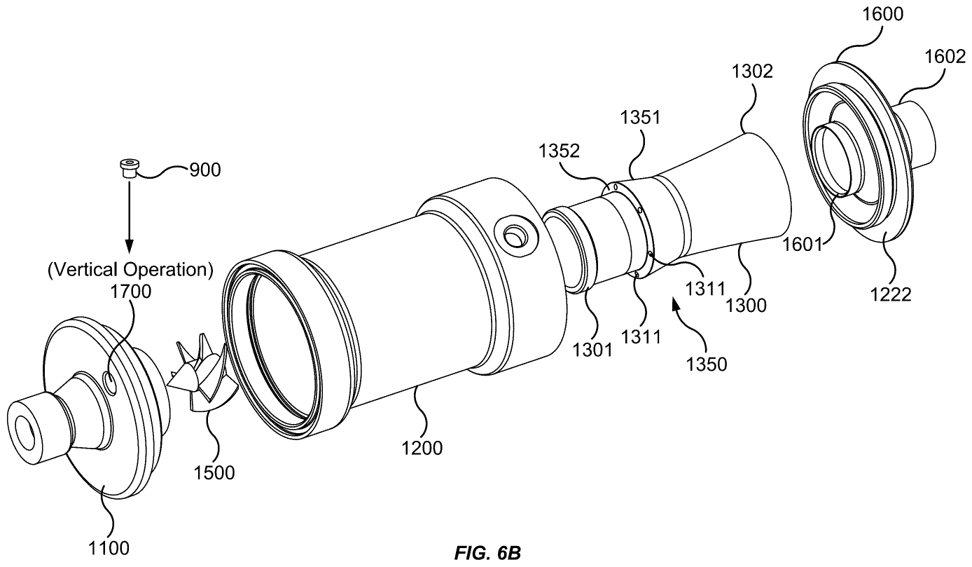

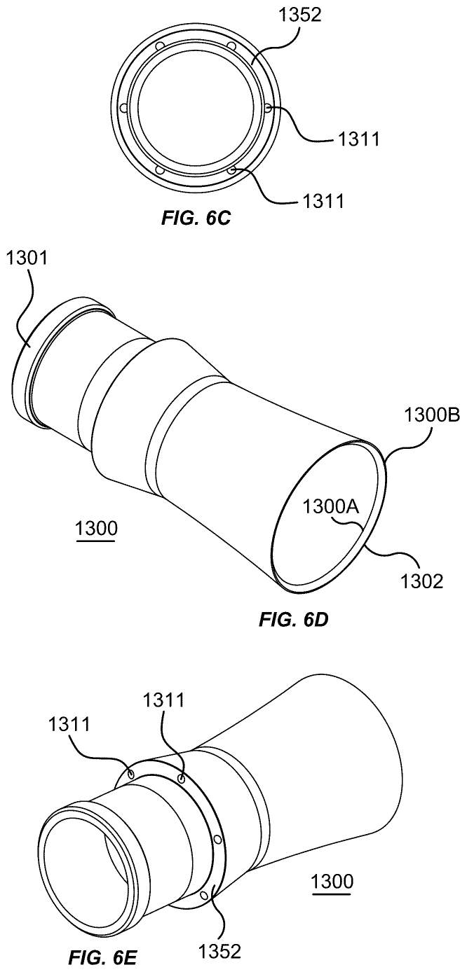

Using the illustrated aspect of the liquid separator device shown in FIGS. 5A-5F, and 6A-6B for reference, a liquid separator device 2 comprises (a) a hollow inlet duct 1100 having a first open inlet duct end 1101 and a second open inlet duct end 1102, the second open inlet duct end further comprising a first housing end cap 1201; (b) a hollow separation duct 1300 having an inner separation duct wall 1300A, and an outer separation duct wall 1300B further comprising a collar 1350 having an outwardly extending tapered collar wall 1351 and a collar lip 1352 (the lip illustrated as generally perpendicular to the horizontal axis HA between housing ends discussed below), a plurality of venturi flow radial openings 1311 passing through the collar lip 1352 and the inner separation duct wall 1300A; a first open separation duct end 1301 and a second open separation duct end 1302, wherein the collar 1350 is arranged between the first open separation duct end 1301 and the second open separation duct end 1302; a separation cavity 1400 from the first open separation duct end 1301 to the second open separation duct end 1302 bounded by the inner separation duct wall 1300A, wherein the first housing end cap 1201 of the second open inlet duct end 1102 is arranged coaxially in the first open separation duct end 1301, with a first annular space 11A between the first housing end cap 1201 and the first open separation duct end 1301; (c) a vortex generator 1500 comprising a plurality of helical vanes 1501, arranged concentrically within the hollow inlet duct 1100, and retained axially between the first open separation duct end 1301 and the second open inlet duct end 1102 including the first housing end cap 1201; (d) a hollow outlet duct 1600 having a first open outlet duct end 1601 and a second open outlet duct end 1602, the second open outlet duct end 1602 further comprising a second housing end cap 1222; (e) a hollow housing 1200 having an inner housing wall 1200A, an outer housing wall 1200B, a first open housing end 1211, an oppositely arranged second open housing end 1212, with a horizontal axis HA between the first open housing end 1211 and the oppositely arranged second open housing end 1212, wherein the separation duct 1300 is arranged concentrically along the horizontal axis HA within the hollow housing 1200; (f) the first housing end cap 1201 of the second open inlet duct end 1102 connected concentrically to the first open housing end 1211; (g) the second housing end cap 1222 of the first open outlet duct end 1601 connected concentrically to both the second open housing end 1212 and the hollow outlet duct 1600; (h) a hollow collection sump port 1700 in fluid communication with the first housing end cap 1201 of the second open inlet duct end 1102, or in fluid communication with the hollow housing 1200 through the inner and outer housing walls 1200A, 1200B adjacent the second housing end cap 1222 of the first open outlet duct end 1601, the hollow collection sump port 1700 including an orifice 900 (see, FIGS. 3A-3D) restricting flow therethrough; (i) a collection cavity 1800 within the hollow housing 1200, surrounding the outer separation duct wall 1300B including the collar 1350 of the hollow separation duct 1300, bounded by the first housing end cap 1201 of the second open inlet duct end 1102, the second housing end cap 1222 of the first open outlet duct end 1601, and the hollow collection sump port 1700; wherein the second open separation duct end 1302 is arranged coaxially with respect to the first open outlet duct end 1601, with a second annular space 12A between the second open separation duct end 1302 and the first open outlet duct end 1601, the second annular space providing a fluid flow path from the separation cavity 1400 to the collection cavity 1800, and through the hollow collection sump port. Optionally, the presence of an orifice (or orifice plate, or orifice fitting) 900 (or as an alternative to an orifice, a separate drain valve) at the hollow collection sump port restricts the flow of liquid (water) and some gas sufficiently to enable removal of liquid into a scavenge pipework and limit the loss of process gas to below a specified level.

Optionally, the hollow separation duct (e.g., as illustrated as hollow separation duct 1300) can have a general “hourglass” shape. Without being bound by any particular mechanism, it is believe that when the device including such a separation duct is operated, e.g., vertically, water is drawn away from the center, improving separation. Such a configuration can also allow the use of a larger first open end outlet duct diameter to be used, reducing pressure loss.

FIGS. 7A-7B are drawings illustrating, schematically, venturi-induced air cycling during fluid flow through the illustrated aspect of the water separation device 2000 operated vertically (FIG. 7A) or horizontally (FIG. 7B), wherein a portion of the venturi-induced air flow passes through the radial openings.

In some aspects, as shown in FIGS. 7A and 7B, the water separation device can have drain vent ports and/or system purge ports. If desired, an orifice can be arranged in/by a drain vent port. Optionally, an aspect of the device can include a drain with an additional vent port if a standalone mechanical drain valve with its own reservoir is used, the prevents an airlock and allows the drain port to function properly. If a solenoid valve is used, the “drain vent” is not required, and only a single drain point can be used if desired. A purge port can be desirable for an anode gas version, where there can be a sporadic need to purge a build up of nitrogen gas from the system.

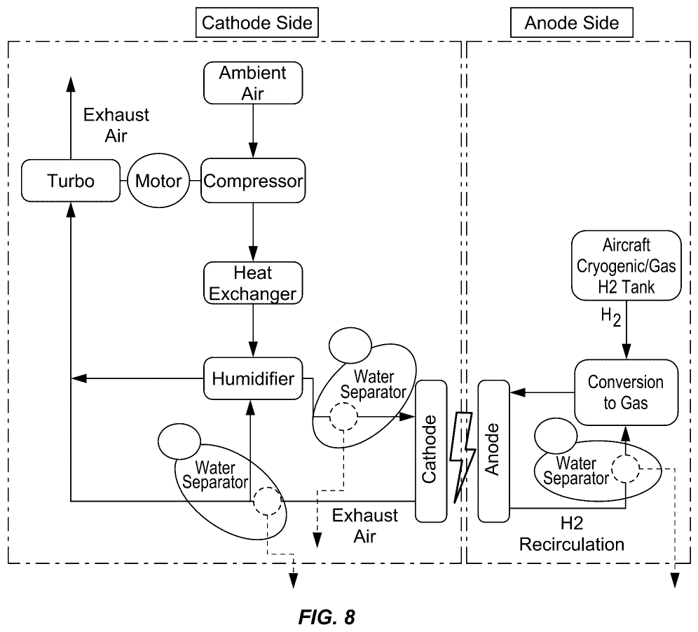

FIG. 8 is a drawing showing, diagrammatically, that water separation devices according to aspects of the invention can be arranged upstream and/or downstream of fuel cells according to aspects of the invention to provide aspects of water separation systems.

Typically, in use, the first open inlet duct end connects with customer ducting, and the hollow collection sump port or the second open end of the hollow collection sump interfaces with customer scavenge ducting and is associated with an orifice for restricting scavenge flow.

A variety of materials and processes can be utilized to provide water separation devices according to aspects of the invention. Suitable materials include, but are not limited to, aluminum and aluminum alloys (various grades including AlSi10Mg, Scalmalloy® (an alloy made from scandium, aluminum and magnesium alloy), A20X™ (aluminum-copper alloy)) and stainless steel (including stainless steel 316/316L, Inconel® 718 and 625 (nickel-based alloys)). In other aspects, additive manufacturing (sometimes referred to as “additive layer manufacturing” or “3D printing”) can be utilized, wherein components are typically formed by repeated depositions of a metal powder bound together with an activatable binder (e.g., binder jetting, sometimes referred to as “drop on powder”), typically followed by agglomerating the powder, e.g., by sintering. If desired, various components can be manufactured together via additive manufacturing in a continuous operation at substantially the same time.

Any suitable additive manufacturing equipment can be used, and a variety of production 3D printers are suitable and commercially available.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred aspects of this invention are described herein, including the best mode known to the inventors for carrying out the invention. Variations of those preferred aspects may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law.

Moreover, any combination of the above-described elements in all possible variations thereof is encompassed by the invention unless otherwise indicated herein or otherwise clearly contradicted by context.

1. A liquid separator device comprising
(a) a hollow inlet duct having a first open inlet duct end and a second open inlet duct end, the second open inlet duct end further comprising a first housing end cap;
(b) a hollow separation duct having an inner separation duct wall, an outer separation duct wall, a plurality of venturi flow radial slits passing through the outer and inner separation duct walls; a first open separation duct end, a second open separation duct end; a separation cavity from the first open separation duct end to the second open separation duct end bounded by the inner separation duct wall, wherein the first housing end cap of the second open inlet duct end is arranged coaxially in the first open separation duct end, with a first annular space between the first housing end cap and the first open separation duct end;
(c) a vortex generator comprising a plurality of helical vanes, arranged concentrically within the hollow inlet duct, and retained axially between the first open separation duct end and the second open inlet duct end including the first housing end cap;
(d) a hollow outlet duct having a first open outlet duct end and a second open outlet duct end;
(e) a hollow housing having an inner housing wall, an outer housing wall, a first open housing end, an oppositely arranged second open housing end, with a horizontal axis between the first open housing end and the oppositely arranged second open housing end, and a third open housing end arranged perpendicular to the horizontal axis or parallel to the horizontal axis, wherein the separation duct is arranged concentrically along the horizontal axis within the hollow housing;
(f) the first housing end cap of the second open inlet duct end connected concentrically to the first open housing end;
(g) a second housing end cap connected concentrically to both the second open housing end and the hollow outlet duct:
(h) a hollow collection sump having a first open sump end and a second open sump end, wherein the first open sump end is connected to the third open housing end, the hollow collection sump including an orifice restricting flow therethrough;
(i) a collection cavity within the hollow housing, surrounding the outer wall of the hollow separation duct, bounded by the first housing end cap of the second open inlet duct end, the second housing end cap, and the first open sump end;
wherein the second open separation duct end is arranged coaxially with respect to the first open outlet duct end, with a second annular space between the second open separation duct end and the first open outlet duct end, the second annular space providing a fluid flow path from the separation cavity to the collection cavity.

2. A liquid separator system, comprising a fuel cell having an anode side and a cathode side, and the water separation device of claim 1 in fluid communication with the cathode side, wherein the water separation device is arranged upstream of the cathode side.

3. A liquid separator system, comprising a fuel cell having an anode side and a cathode side, and the liquid separator device of claim 1 in fluid communication with the anode side, wherein the liquid separator device is arranged downstream of the anode side.

4. The liquid separator system of claim 2, further comprising an additional liquid separator device of claim 1 arranged downstream of the anode side.

5. A method for processing fluid, the method comprising passing a fluid comprising liquid and gas into the liquid separator device of claim 1, and separating liquid from gas, including passing separated gas through the hollow outlet duct, and passing separated liquid through the hollow collection sump or hollow collection sump port.

6. The method of claim 5, wherein the liquid comprises water, and the gas comprises hydrogen.
